(19) United States
(12) Patent Application Publication
(10) Pub. No.: US 2018/0298986 A1
(43) Pub. Date: Oct. 18, 2018

(54) RATCHET LOAD BINDER

(71) Applicant: Rick Larry Rolof, Onoway (CA)

(72) Inventor: Rick Larry Rolof, Onoway (CA)

(21) Appl. No.: 15/947,686

(22) Filed: Apr. 6, 2018

Related U.S. Application Data
(60) Provisional application No. 62/484,751, filed on Apr. 12, 2017.

(51) Int. Cl. F16G 11/12

(52) U.S. Cl. CPC F16G 11/12

(57) ABSTRACT

A tool for tightening or loosening a load retaining chain, includes a tie rod having a central axis and oppositely threaded opposing ends; chain hooks each having a threaded pin engaging the threaded tie rod ends; and a lever arm having a ratcheting mechanism to rotate the tie rod and a far end configured to engage a chain link. The lever arm may pivot about an axis substantially perpendicular to the tie rod central axis.

### FIELD OF THE INVENTION

The present invention relates to a ratchet load binder.

### BACKGROUND

Ratchet load binders are mechanical levers designed to tighten a chain for securing a load. The chains are typically heavy duty haul chains and are difficult to handle manually.

Conventional ratchet load binders remain awkward to use because the chain must be manually tightened by pulling on the ends of the chain to a certain degree before the load binder can be successfully used.

### SUMMARY OF THE INVENTION

In one aspect, the invention comprises a ratchet load binder having a bi-directional lever arm. In one embodiment, the load binder comprises:

(a) a tie rod having a central axis and oppositely threaded opposing ends;

(b) first and second chain hooks each having a threaded pin engaging the threaded tie rod ends:

(c) a lever arm having a far end, a handle end, and a ratcheting mechanism to rotate the tie rod about its central axis, wherein the far end is configured to engage a chain link and the lever arm is configured to pivot sideways, about an axis substantially perpendicular to the tie rod central axis.

In one embodiment, the ratcheting mechanism comprises pins to allow the lever arm to pivot sideways.

In another aspect, the invention comprises a method of tightening or untightening a chain, comprising the steps of:

(a) connecting a ratcheting load binder having a tie rod having a central axis and oppositely threaded opposing ends, first and second chain hooks each having a threaded pin engaging the threaded tie rod ends, and a lever arm having a far end, a handle end, and a ratcheting mechanism to rotate the tie rod about its central axis, wherein the far end is configured to engage a chain link and the lever arm is configured to pivot about an axis substantially perpendicular to the tie rod central axis, such that the first and second chain hooks each engage a chain link;

(b) engaging a chain link with the far end of the lever arm;

(c) pivoting the lever arm to shorten the chain; and

(d) repositioning one or both of the first and second chain hooks.

This levering action is repeated until the ratcheting adjustment can be made to sufficiently tighten the chain.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 (Prior Art) shows a conventional ratchet load binder.

FIG. 2 shows an embodiment of the present invention.

FIG. 3 shows another view of the embodiment of FIG. 2.

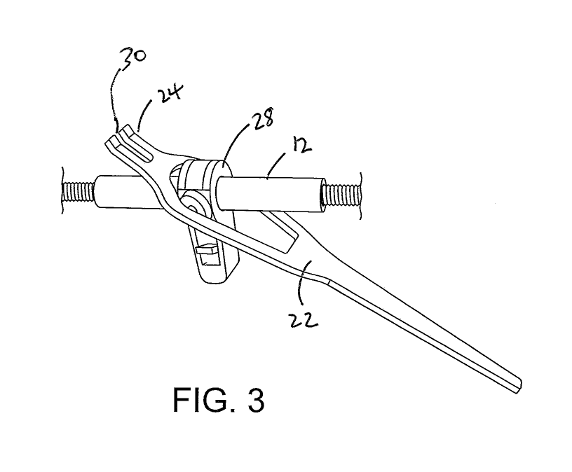

### DETAILED DESCRIPTION

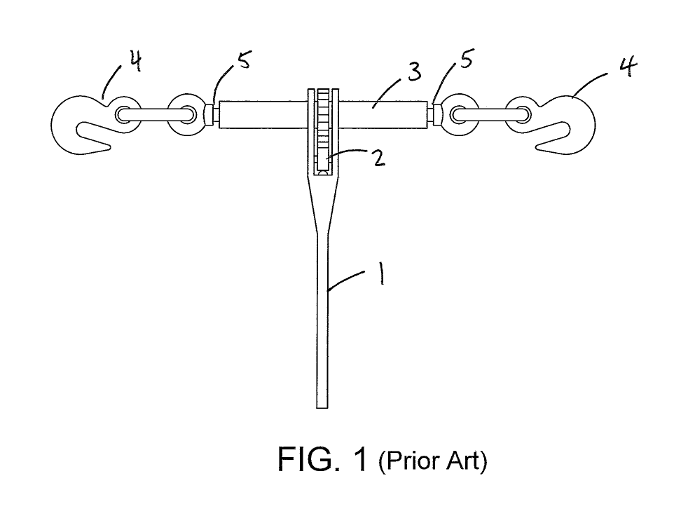

A typical prior art design is shown in FIG. 1. A ratchet lever (1) has a pawl (2) which engages a gear to rotate a tie rod (3) configured as a turnbuckle, having opposing threads at opposite ends. Chain-engaging hooks (4) attached to pins (5) which are threaded into the tie rod (3). By ratcheting the tie rod, the chain may be tightened or loosened, depending on the direction of rotation.

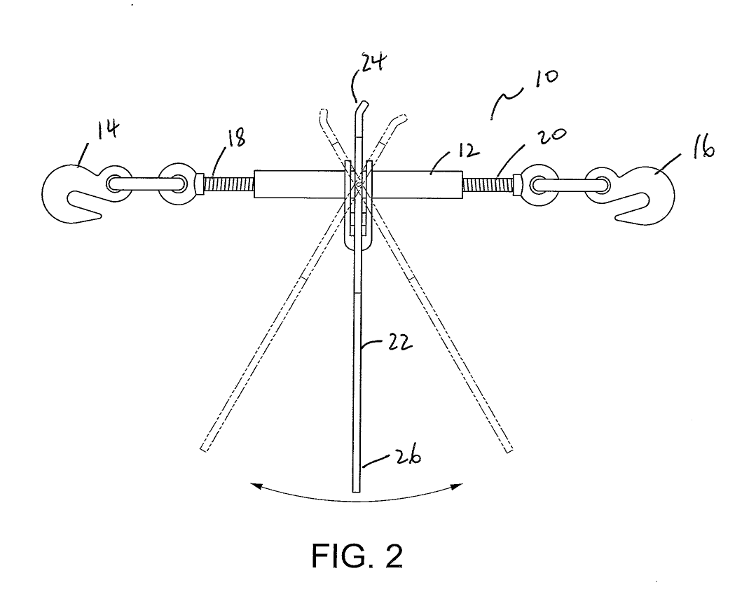

In one aspect of the invention, as shown schematically in FIG. 2, the invention comprises a load binder (10) having:

(a) a tie rod (12) having a central axis and oppositely threaded opposing ends;

(b) first and second chain hooks (14, 16) each having a threaded pin (18, 20) engaging the threaded tie rod ends;

(c) a lever arm (22) having a far end (24), a handle end (26), and a ratcheting mechanism (28) to rotate the tie rod about its central axis, wherein the far end is configured to engage a chain link and the lever arm is configured to pivot side-to-side, about an axis substantially perpendicular to the tie rod central axis. In one embodiment, the ratcheting mechanism (28) comprises pins to allow the lever arm to pivot sideways.

The far end (24) may have a single prong or a double prong (30) which engages a chain between two chain links.

In one embodiment, it is preferably that the lever arm pass on both sides of the ratcheting mechanism (28) is shown in the Figures, so as to minimize twisting of the device when the lever arm (22) is pivoted side-to-side. Thus, the tie rod (12) central axis and the lever arm (22) central axis are co-planar. In one embodiment lever arm pivots about a top pin and a bottom pin disposed on the ratcheting mechanism (28).

In use, the two chain hooks (14, 16) are attached to a chain. The goal is to shorten the chain by bringing the two chain ends closer together. The user uses the far end (24) to engage the chain and pull on it by pivoting the lever arm sideways. As the lever arm pivots about an axis which is perpendicular to the tie rod axis, the chain is shortened, and the one chain hook (14) can be repositioned onto a different chain link. This sideways levering action can be repeated as necessary.

Once the chain has been shortened to a desired degree by the sideways levering, the lever arm may then be used to rotationally ratchet the tie rod in a conventional manner to complete the chain tightening procedure.

The lever arm (22) may also be used to remove the load binder (10) by taking tension off the load binder, in order to remove or reposition the chain hooks.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

What is claimed is:

1. A load binder comprising:
(a) a tie rod having a central axis and oppositely threaded opposing ends;
(b) first and second chain hooks each having a threaded pin engaging the threaded tie rod ends:
(c) a lever arm having a far end, a handle end, and a ratcheting mechanism to rotate the tie rod about its central axis, wherein the far end is configured to engage a chain link and the lever arm is configured to pivot about an axis substantially perpendicular to the tie rod central axis.

2. The load binder wherein the far end of the lever arm has a double prong configuration to engage a chain between two adjacent chain links.

3. A method of tightening or untightening a chain, comprising the steps of:
(a) connecting a ratcheting load binder having a tie rod having a central axis and oppositely threaded opposing ends, first and second chain hooks each having a threaded pin engaging the threaded tie rod ends, and a lever arm having a far end, a handle end, and a ratcheting mechanism to rotate the tie rod about its central axis, wherein the far end is configured to engage a chain link and the lever arm is configured to pivot about an axis substantially perpendicular to the tie rod central axis, such that the first and second chain hooks each engage a chain link;
(b) engaging a chain link with the far end of the lever arm;
(c) pivoting the lever arm to shorten the chain; and
(d) repositioning one or both of the first and second chain hooks.
